(19) United States
(12) Patent Application Publication
(10) Pub. No.: US 2026/0254271 A1
(43) Pub. Date: Aug. 27, 2026

(54) METHOD AND DEVICE FOR PROTECTING BACKUP POWER SUPPLY, AND ENERGY STORAGE POWER STATION

(71) Applicant: CSI ENERGY STORAGE CO., LTD., Suzhou (CN)

(72) Inventors: Guijiang HUANG, Suzhou (CN); Zhen JIANG, Suzhou (CN); Shuai GUAN, Suzhou (CN); Meiqi YAO, Suzhou (CN); Lijun GAO, Suzhou (CN)

(21) Appl. No.: 19/393,805

(22) Filed: Nov. 19, 2025

(30) Foreign Application Priority Data
Feb. 24, 2025 (CN) 202510199919.6

(51) Int. Cl. H02J 9/06; H02J 3/001; H02J 7/00; H02J 7/40; H02J 7/63; H02J 7/80; H02J 7/90

(52) U.S. Cl. CPC H02J 9/068; H02J 3/001; H02J 7/40; H02J 7/63; H02J 7/80; H02J 7/865; H02J 7/933

(57) ABSTRACT

A method for protecting a backup power supply, a device for protecting a backup power supply and an energy storage power station. The method is applied to an energy storage power station. The energy storage power station includes a load connected to a backup power supply for being powered. The protection method includes obtaining, when the backup power supply is in a power-supplying state, a power-supplying state parameter of the backup power supply, and controlling a power-supplying connection state between the backup power supply and the load based on the power-supplying state parameter. This method can provide protection for the backup power supply and extends the service life of the backup power supply.

### CROSS-REFERENCE TO RELATED APPLICATION

The present application claims priority to Chinese Patent Application No. 202510199919.6 filed with China National Intellectual Property Administration on February 24, 2025 and entitled “METHOD AND DEVICE FOR PROTECTING BACKUP POWER SUPPLY, AND ENERGY STORAGE POWER STATION”, which is incorporated herein by reference in its entirety.

### FIELD

The present disclosure relates to the technical field of power supplies, and more particularly, to a method for protecting a backup power supply, a device for protecting a backup power supply and an energy storage power station.

### BACKGROUND

In related art, a backup power supply of an energy storage system may operate for extended periods. However, prolonged operation may cause damage to the backup power supply. In cases of severe damage, the only option is to replace the backup power supply, resulting in substantial losses.

### SUMMARY

The present disclosure aims to resolve at least one of the technical problems existing in the related art. Therefore, one aim of the present disclosure is to provide a method for protecting a backup power supply. The method realizes protection of the backup power supply, extends the service life of the backup power supply.

A second aim of the present disclosure is to provide a device for protecting a backup power supply.

A third aim of the present disclosure is to provide a non-transitory computer storage medium.

A fourth aim of the present disclosure is to provide an energy storage power station.

To overcome the above problems, an embodiment of a first aspect of the present disclosure provides a method for protecting a backup power supply, applied to an energy storage power station. The energy storage power station includes a load connected to the backup power supply for being powered. The method includes obtaining, when the backup power supply is in a power-supplying state, a power-supplying state parameter of the backup power supply and controlling a power-supplying connection state between the backup power supply and the load based on the power-supplying state parameter.

According to the method for protecting a backup power supply of the embodiment of the present disclosure, when the backup power supply is supplying power, the power-supplying state parameter of the backup power supply is obtained, and based on the power-supplying state parameter, a determination is made as to whether the backup power supply is at risk of being damaged, and then the power-supplying connection state between the backup power supply and the load can be controlled. That is, based on the power-supplying state parameter, when it is determined that the backup power supply is potentially damaged, especially in scenarios involving prolonged operation of the backup power supply, the backup power supply is cut off so as to be protected, thereby extending the service life of the backup power supply.

In some embodiments, the controlling the power-supplying connection state between the backup power supply and the load based on the power-supplying state parameter includes: determining whether the power-supplying state parameter meets a power-off protection condition; and controlling, in response to that the power-supplying state parameter meets the condition, the power-supplying connection state between the backup power supply and the load to be a disconnected state; controlling, in response to that the power-supplying state parameter does not meet the condition, the power-supplying connection state between the backup power supply and the load to be a connected state and maintaining power supplying.

In some embodiments, the power-supplying state parameter includes one or more of a power-supplying duration of the backup power supply and an available power-supplying voltage of the backup power supply.

In some embodiments, when determining whether the power-supplying state parameter meets the power-off protection condition, a priority of determining the power-supplying duration is higher than a priority of determining the available power-supplying voltage.

In some embodiments, the energy storage power station further includes a main power supply for supplying power to the backup power supply and/or the load, and the method further includes controlling, when it is determined that the main power supply is in an abnormal state, the backup power supply to enter the power supplying state.

In some embodiments, the method further includes obtaining the available power-supplying voltage of the backup power supply after determining that the main power supply has recovered from the abnormal state to a normal state and controlling the power-supplying connection state between the backup power supply and the load based on the available power-supplying voltage.

In some embodiments, the controlling the power-supplying connection state between the backup power supply and the load based on the available power-supplying voltage includes controlling, when it is determined that the available power-supplying voltage is greater than or equal to a first preset power-supplying voltage, the power-supplying connection state between the backup power supply and the load to be a connected state and stopping the power supplying; and controlling, when it is determined that the available power-supplying voltage is smaller than the first preset power-supplying voltage, the power-supplying connection state between the backup power supply and the load to be a disconnected state.

In some embodiments, the method further includes: transmitting, when it is determined that the available power-supplying voltage is greater than a second preset power-supplying voltage, a first-level power level indication signal; transmitting, when it is determined that the available power-supplying voltage is less than or equal to the second preset power-supplying voltage and is greater than or equal to the first preset power-supplying voltage, a second-level power level indication signal; and transmitting, when it is determined that the available power-supplying voltage is less than the first preset power-supplying voltage, a third-level power level indication signal.

An embodiment in a second aspect of the present disclosure provides a device for protecting a backup power supply. The device includes at least one processor and a memory communicatively connected to the at least one processor. The memory stores a computer program executable by the at least one processor, the computer program when executed by the at least one processor, implements the method for protecting the backup power supply according to any of the above embodiments.

The device for protecting a backup power supply according to the embodiment of the present disclosure, by implementing the method for protecting the backup power supply using the processor, can provide protection for the backup power supply and thus can extend the service life of the backup power supply.

An embodiment in a third aspect of the present disclosure provides non-transitory computer storage medium on which a computer program is stored. When executed by the processor, the computer program implements the method for protecting a backup power supply described in any of the above embodiments.

An embodiment in a fourth aspect of the present disclosure provides an energy storage power station. The energy storage power station includes: a backup power supply and a load connected to the backup power supply for being powered; and the device for protecting the backup power supply according to any of the above embodiments, the device for protecting the backup power supply being arranged between the backup power supply and the load.

The energy storage power station according to the embodiment of the present disclosure can protect the backup power supply based on the device for protecting a backup power supply located between the backup power supply and the load, thereby extending the service life of the backup power supply.

The additional aspects and advantages of the present disclosure will be partially presented in the following description, partially become apparent from the description below, or be understood through the practice of the present disclosure.

### BRIEF DESCRIPTION OF THE DRAWINGS

The above and/or other additional aspects and advantages of the present disclosure become apparent and comprehensible from the description of embodiments in connection with accompanying drawings, in which:

FIG. 1 is a flowchart of a method for protecting a backup power supply according to an embodiment of the present disclosure;

FIG. 2 is a flowchart of a method for protecting a backup power supply according to another embodiment of the present disclosure;

FIG. 3 is a flowchart of a method for protecting a backup power supply according to yet another embodiment of the present disclosure;

FIG. 4 is a block diagram showing a structure of a device for protecting a backup power supply according to an embodiment of the present disclosure;

FIG. 5 is a block diagram showing a structure of an energy storage power station according to an embodiment of the present disclosure; and

FIG. 6 is a schematic diagram of an energy storage power station according to an embodiment of the present disclosure.

### Reference numerals:

energy storage power station 100;

device for protecting a backup power supply 10;

backup power supply 20;

load 30;

processor 1;

memory 2.

### DETAILED DESCRIPTION

The following describes the embodiments of the present disclosure in detail. The embodiments described with reference to the accompanying drawings are exemplary.

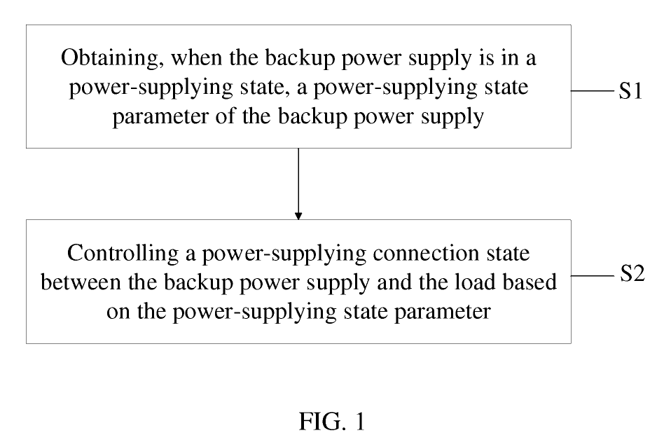

The following describes a method for protecting a backup power supply according to an embodiment of the present disclosure with reference to FIG. 1. The method for protecting a backup power supply includes steps S1 to S2, with the specific steps as follows:

At step S1, when the backup power supply is in a power-supplying state, a power-supplying state parameter of the backup power supply is obtained.

Specifically, when the backup power supply is in a power-supplying state, power-supplying state parameters of the backup power supply can be obtained through measuring instruments or sensors. These parameters can then be used to assess the likelihood of damage of the backup power supply, enabling timely power disconnection to protect the backup power supply before actual damage occurs. The power-supplying state parameters may include a current value, a voltage value, an operating temperature, an output power, and health status of the remaining capacity of the backup power supply, among others, and are not specifically limited herein.

At step S2, a power-supplying connection state between the backup power supply and the load is controlled based on the power-supplying state parameter.

Specifically, to prevent damage to the backup power supply during operation due to improper use or other factors, the present disclosure determines whether the backup power supply is damaged based on its power-supplying state parameter, and subsequently controls a power-supplying connection state between the backup power supply and the load based on the power-supplying state parameter. That is, the backup power supply is protected based on the power-supplying state parameter. Therefore, when the backup power supply is operating, its usage condition can be determined in real time based on the power-supplying state parameter, and thus the backup power supply can be protected timely before potential damage to the backup power supply occurs to extend service life of the backup power supply, particularly addressing issues of damage resulting from prolonged operation of the backup power supply.

According to the method for protecting a backup power supply of the embodiment of the present disclosure, when the backup power supply is supplying power, the power-supplying state parameter of the backup power supply is obtained, and based on the power-supplying state parameter, a determination is made as to whether the backup power supply is at risk of being damaged, and then the power-supplying connection state between the backup power supply and the load can be controlled. That is, based on the power-supplying state parameter, when it is determined that the backup power supply is potentially damaged, especially in scenarios involving prolonged operation of the backup power supply, the backup power supply is cut off so as to be protected, thereby extending the service life of the backup power supply.

In some embodiments, the controlling the power-supplying connection state between the backup power supply and the load based on the power-supplying state parameter includes: determining whether the power-supplying state parameter meets a power-off protection condition; and controlling, in response to that the power-supplying state parameter meets the condition, the power-supplying connection state between the backup power supply and the load to be a disconnected state; controlling, in response to that the power-supplying state parameter does not meet the condition, the power-supplying connection state between the backup power supply and the load to be a connected state and maintaining power supplying.

Specifically, when the power-supplying state parameter meets a power-off protection condition, it indicates that continued operation of the backup power supply may result in damage. To prevent such damage that would increase the operating costs of the energy storage power station, power-off protection should be implemented. Therefore, the power-supplying connection state between the backup power supply and the load should be a disconnected state, and the backup power supply should enter low-power mode. When the power-supplying state parameter does not meet the power-off protection condition, the backup power supply can continue operating. In this case, the power-supplying connection state between the backup power supply and the load can be controlled to remain a connected state to ensure continued power supplying. In this way, the backup power supply continues operating to maintain power supply to the load.

In some embodiments, the power-supplying state parameter includes a plurality of state parameters. The determining whether the power-supplying state parameter meets the power-off protection condition includes determining a priority corresponding to each state parameter and determining whether the plurality of state parameters meet the power-off protection condition based on the priority of each status parameter.

Specifically, the power-supplying state parameter includes a plurality of state parameters, and the evaluation of each parameter reflects a different requirement. Therefore, based on different requirements, the priority for determining each state parameter can be pre-configured or manually set based on the energy storage power station's demand for the load and/or the power safety of the backup power supply. For example, the power-supplying state parameter include two status parameters, i.e., a voltage value and an operating temperature. The priority for determining the operating temperature can be set higher than that for the voltage value according to actual needs. Consequently, during condition assessment, it is first ensured that the operating temperature meets the power-off protection condition, then it determines whether the voltage value satisfies the power-off protection condition. In other words, even if the voltage value meets the power-off protection condition, the backup power supply will not be subject to the power-off protection if the operating temperature does not meet the power-off protection condition. As another example, when the load is a fire protection system, the fire safety requirement of the energy storage power station take precedence over the need to protect the backup power supply. Thus, ensuring the normal operation of the fire protection system is prioritized. This involves evaluating power supply duration to meet the fire safety requirement of the energy storage power station, and assessing the voltage to fulfill the protection requirement of the backup power supply. In this case, the priority for determining power supply duration in the power-supplying state parameter should be higher than that for voltage, enabling protection of the backup power supply under the premise of fulfilling the fire safety requirements of the energy storage power station.

In some embodiments, the power-supplying state parameter includes one or more of a power-supplying duration of the backup power supply and an available power-supplying voltage of the backup power supply.

Specifically, determining whether the power-supplying duration of the backup power supply meets the power-off protection condition can allow the load to satisfy its operational requirement. Determining whether the available power-supplying voltage of the backup power supply meets the power-off protection condition can allow the backup power supply to satisfy its protection requirement. Based on the different priorities for determining power-supplying duration and the available power-supplying voltage, different user requirements can be accommodated.

In some embodiments, when determining whether the power-supplying state parameter meets the power-off protection condition, a priority of determining the power-supplying duration is higher than a priority of determining the available power-supplying voltage.

Specifically, the priority of determining the power-supplying duration is higher than the priority of determining the available power-supplying voltage. At this time, a priority of normal operation of the load is higher than a priority of protection of the backup power supply. Therefore, when determining whether power-supplying connection state meets the power-off protection condition, the requirement for the normal operation of the load such as the fire protection system should be met first, then the protection requirement for the backup power supply should be met.

In some embodiments, the power-off protection condition includes: a power-supplying duration being greater than a preset power-supplying duration, and the available power-supplying voltage being less than a third preset power-supplying voltage.

The preset power-supplying duration can be set according to actual requirements. For example, taking the fire protection system as an example, the preset power-supplying duration can be customized according to fire safety requirements in different regions, thereby effectively extending the service life of backup power supply in fire protection system and enhancing stability of the fire protection system. The third preset power-supplying voltage need to be configured based on the count and characteristics of batteries in the backup power supply. For example, The third preset power-supplying voltage can be 17V, but the third preset power-supplying voltage is not limited thereto.

Specifically, it is firstly determined whether the power-supplying duration is greater than the preset power-supplying duration. The backup power supply shall ensure that the power-supplying duration for the load reaches the preset power-supplying duration, thereby satisfying the normal operational requirement of the load. If it is determined that the power-supplying duration is greater than the preset power-supplying duration, then it is determined whether the available power-supplying voltage is less than the third preset power-supplying voltage. If the available power-supplying voltage is lower than the third preset power-supplying voltage, continued power supplying of the backup power supply may be subject to damage, and thus the backup power supply should be protected. On the contrary, if the available power-supplying voltage is not lower than the third preset power-supplying voltage, the backup power supply can still operate. Thus, when the power-supplying duration is greater than the preset power-supplying duration and the available power-supplying voltage is lower than the third preset power-supplying voltage, the power-supplying state parameter meets power-off protection condition, the power-supplying connection between the backup power supply and the load is controlled to become a disconnected state. Under the premise of ensuring the normal operation requirement of the load, the backup power supply is protected to extend its service life. However, if it is determined that the power-supplying duration is less than or equal to the preset power-supplying duration, but the available power-supplying voltage is below the third preset supply voltage, the backup power supply shall continue providing power to the load to ensure stable operation of the load as a priority. The preset power-supplying duration and the available power-supplying voltage can be configured according to actual conditions; no specific restrictions are imposed thereto.

In some embodiments, the energy storage power station further includes a main power supply for supplying power to the backup power supply and/or the load. The method further includes controlling, when it is determined that the main power supply is in an abnormal state, the backup power supply to enter the power supplying state.

In some embodiments, the method of the present disclosure further includes obtaining the available power-supplying voltage of the backup power supply after determining that the main power supply has recovered from the abnormal state to a normal state; and controlling the power-supplying connection state between the backup power supply and the load based on the available power-supplying voltage.

Specifically, after the main power supply of the energy storage power station resumes a normal operation, the load is supplied by the main power supply, while the backup power supply is also supplied by the main power supply. Meanwhile, in the present disclosure, the power-supplying connection state between the backup power supply and the load will not be directly controlled to be a connected state after the main power supply resumes operation. Instead, the available power-supplying voltage of the backup power supply will be detected and it is determined whether to enable the power-supplying connection state between the backup power supply and the load to be a connected state based on the available power-supplying voltage.

In some embodiments, the controlling the power-supplying connection state between the backup power supply and the load based on the available power-supplying voltage includes controlling, when it is determined that the available power-supplying voltage is greater than or equal to a first preset power-supplying voltage, the power-supplying connection between the backup power supply and the load to be a connected state and stopping the power supplying. In this way, when the main power supply is in an abnormal state again, the backup power supply can continue to supply power to the load, ensuring the needed normal operation of the load. However, when it is determined that the available power-supplying voltage is smaller than the first preset power-supplying voltage, it indicates that the battery power is too low and there may be a problem of battery damage. At this time, the power-supplying connection between the backup power supply and the load is controlled to be a disconnected state, so as to avoid the negative impact on the load caused by battery damage. When the power-supplying connection state is the connected state and power supplying is stopped, it can be understood that the backup power supply is connected to the load so as to allow power supplying, but the backup power supply does not supply power to the load.

In some embodiments, the method further includes transmitting, after the main power supply resumes its normal state, and a power level indication signal based on the available power-supplying voltage of the backup power supply.

Specifically, after the main power supply returns to its normal state, the load is once again supplied by the main power supply. At this point, a state of the backup power supply can be obtained through the available power-supplying voltage, that is, the power level of the backup power supply can be obtained. Thus, the power level of the backup power supply can be obtained based on a power level indication signal, so as to take corresponding measures. If the power level indication signal indicates sufficient power, the backup power supply can function normally. If the power level indication signal indicates insufficient power, in order to ensure the normal operation of the energy storage power station and protect the backup power supply at the same time, corresponding measures should be taken promptly to avoid over-discharge of the current backup power supply, which could otherwise lead to a reduction in the service life of the backup power supply.

In some embodiments, the transmitting the power level indication signal based on the available power-supplying voltage of the backup power supply includes transmitting, when it is determined that the available power-supplying voltage is greater than a second preset power-supplying voltage, a first-level power level indication signal; transmitting, when it is determined that the available power-supplying voltage is less than or equal to the second preset power-supplying voltage and is greater than or equal to the first preset power-supplying voltage, a second-level power level indication signal; and transmitting, when it is determined that the available power-supplying voltage is less than the first preset power-supplying voltage, a third-level power level indication signal.

Specifically, if the available power-supplying voltage is greater than a second preset power-supplying voltage, a first-level power level indication signal is transmitted to notify the maintenance personnel that the backup power supply currently has sufficient power and can operate normally. If the available power-supplying voltage is less than or equal to the second preset power-supplying voltage and is greater than or equal to a first preset power-supplying voltage, a second-level power level indication signal is transmitted to notify the maintenance personnel that the backup power supply can operate normally but is currently at a low power level. If the available power-supplying voltage is less than the first preset power-supplying voltage, a third-level power level indication signal is transmitted to notify the maintenance personnel that the backup power supply has insufficient power and should be replaced promptly. The above multi-level indications indicate the different states of the backup power supply, enabling corresponding measures to be taken. This ensures the normal operation of the energy storage power station while protecting the backup power supply. The first preset power-supplying voltage and the second preset power-supplying voltage can be configured based on factors such as the type of the backup power supply. For example, the backup power supply is a lead-acid battery, with the second preset power-supplying voltage set to 19V and the first preset power-supplying voltage set to 17V, though these values are not specifically limited here. The power-level indication signals may be provided in forms such as sound, light, text, which are also not specifically restricted here.

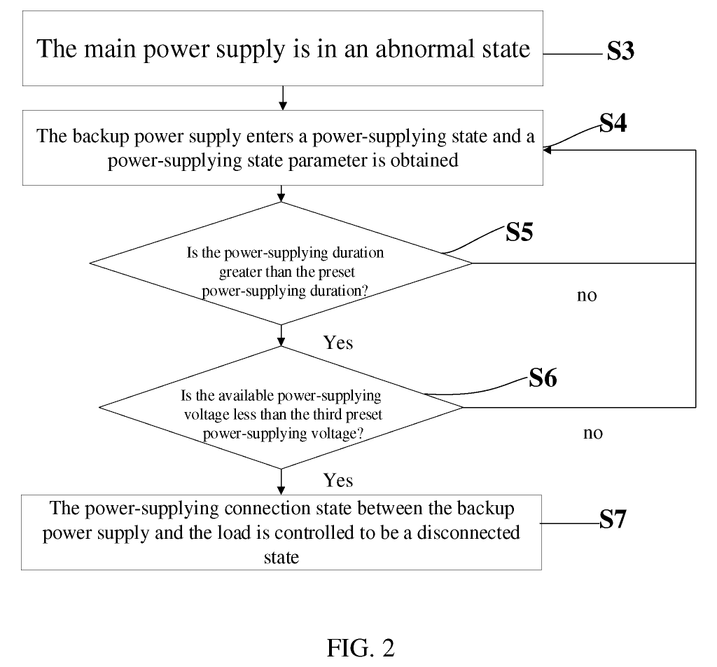

A method for protecting a backup power supply will be described below with reference to FIG. 2 as an example. The specific steps of the method for protecting the backup power supply, when the main power supply is in an abnormal state, are as follows.

At step S3, the main power supply is in an abnormal state.

At step S4, the backup power supply enters a power-supplying state and a power-supplying state parameter is obtained.

At step S5, it is determined whether a power-supplying duration is greater than a preset power-supplying duration. If it is true, step S6 is executed; and if it is not true, step S4 is executed.

At step S6, it is determined whether the available power-supplying voltage is less than a third preset power-supplying voltage. If it is true, step S7 is executed; and if it is not true, step S5 is executed.

At step S7, the power-supplying connection state between the backup power supply and the load to be a disconnected state.

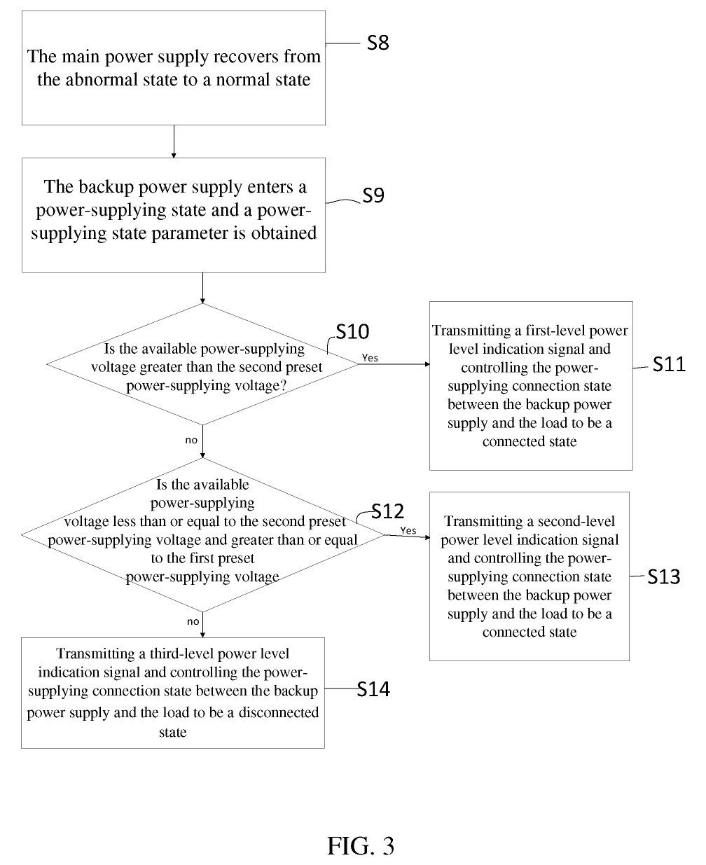

A method for protecting a backup power supply will be described below with reference to FIG. 3 as an example. The specific steps of the method for protecting the backup power supply, when the main power supply returns to an normal state from an abnormal state, are as follows.

At step S8, the main power supply recovers from an abnormal state to a normal state.

At step S9, the backup power supply enters a power-supplying state and a power-supplying state parameter is obtained.

At step S10, it is determined whether the available power-supplying voltage is greater than a second preset power-supplying voltage. If it is true, step S11 is executed. If it is not true, step S12 is executed.

At step S11, a first-level power level indication signal is transmitted and the power-supplying connection between the backup power supply and the load is controlled to be a connected state.

At step S12, it is determined whether the available power-supplying voltage is less than or equal to the second preset power-supplying voltage and is greater than or equal to a first preset power-supplying voltage. If it is true, step S13 is executed. If it is not true, step S14 is executed.

At step S13, a second-level power level indication signal is transmitted and the power-supplying connection between the backup power supply and the load is controlled to be a connected state.

At step S14, a third-level power level indication signal is transmitted and the power-supplying connection between the backup power supply and the load is controlled to be a disconnected state.

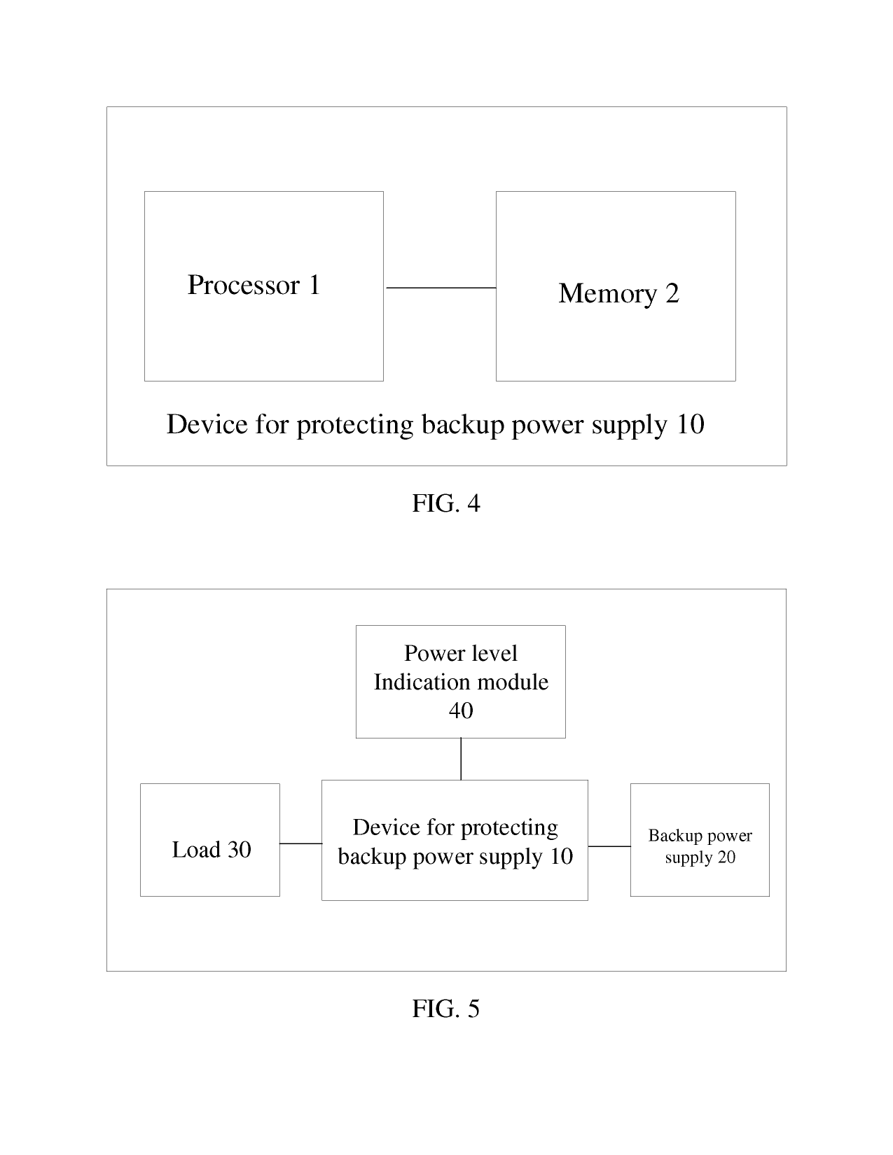

An embodiment in a second aspect of the present disclosure provides a device 10 for protecting a backup power supply. As shown in FIG. 4, the device for protecting a backup power supply includes at least one processor 1 and a memory 2 communicatively connected to the at least one processor 1. The memory 2 stores a computer program executable by the at least one processor 1. The computer program when executed by the at least one processor 1, implements the method for protecting the backup power supply according to any of the above embodiments.

In the device 10 for protecting a backup power supply according to the embodiments of the present disclosure, the processor 1 implements the method for protecting the backup power supply, enabling protecting the backup power supply 30 during operation of the backup power supply 30 and extending the service life of the backup power supply 30.

An embodiment in a third aspect of the present disclosure proposes a non-transitory computer storage medium, on which a computer program is stored. The computer program when executed by the processor 1, implements the method for protecting the backup power supply according to any of the above embodiments.

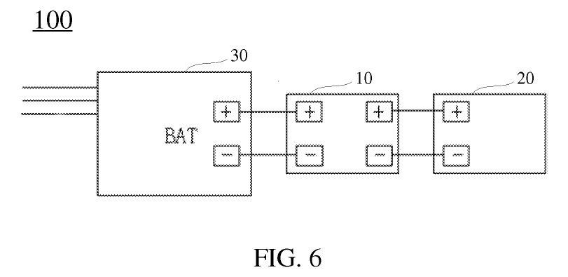

An embodiment in a fourth aspect of the present disclosure provides an energy storage power station 100. As shown in FIG. 5 and FIG. 6, the energy storage power station 100 includes a backup power supply 20 and a load 30. The load 30 is connected to the backup power supply 20 for being powered. The device 10 for protecting the backup power supply is arranged between the backup power supply 20 and the load 30.

In some embodiments, the backup power supply includes, but is not limited to, a lead-acid battery, a lithium battery, a sodium battery, etc.

The energy storage power station 100 according to the embodiment of the present disclosure protects the backup power supply 20 during operation of the backup power supply 20 based on the device 10 for protecting a backup power supply located between the backup power supply 20 and the load 30, thereby extending the service life of the backup power supply 20.

In some embodiments, as shown in FIG. 6, the energy storage power station 100 further includes a power level indication module 40. The power level indication module 40 is configured to indicate a power level based on a power level indication signal.

Specifically, a scenario where the power level indication module 40 provides the power level indication through lighting is taken as an example. When the device 10 for protecting a backup power supply determines that the available power-supplying voltage is greater than the second preset power-supplying voltage, the power level indication module 40 activates a green light according to the first-level power indication signal. When the device 10 for protecting a backup power supply determines that the available power-supplying voltage is less than or equal to the second preset power-supplying voltage and is greater than or equal to the first preset power-supplying voltage, the power level indication module 40 activates a yellow light according to the second-level power indication signal. When the device 10 for protecting a backup power supply determines that the available power-supplying voltage is less than the first preset power-supplying voltage, the power level indication module 40 activates a red light according to the third-level power indication signal.

For example, a fire protection system is taken as the load. when the main power supply is in an abnormal state, the backup power supply must guarantee at least 24 hours of continued operation of the fire protection system. The backup power supply is actually configured as two lead-acid batteries connected in series, with the second preset power-supplying voltage V1 set to 19V, and the first preset power-supplying voltage V2 set to 17V. After the fire protection system is powered on and operates, if the main power supply of the fire protection control unit fails, the backup power supply continues to supply power to the fire protection system and timing is initiated. After 24 hours of operation, the available power-supplying voltage of the backup power supply is determined. When the available power-supplying voltage of the backup power supply is greater than19V, the backup power supply continues operating. When the available power-supplying voltage of the backup power supply is less than or equal to 19V, protection device 10 will disconnect the backup battery from the fire protection control unit and enter a low-power mode. If 17V≤ the available power-supplying voltage of the backup power supply ≤19V is satisfied, the protection device 10 will directly disconnect the backup power supply from the fire protection control unit and enter low-power mode. Upon restoration of the main power supply, the protection device 10 enters a normal operating mode and detects the available power-supplying voltage of the backup power supply. If the available power-supplying voltage is greater than 19V, the protection device 10 will maintain the connection (i.e., a connected state) between the fire protection control unit and the backup power supply and halts the power supplying, and the power level indication module 40 lights a green light. If 17V ≤the available power-supplying voltage≤19V is satisfied, the protection device 10 will maintain the connection between the fire protection control unit and the backup power supply, and the power level indication module 40 lights a yellow light. If the available power-supplying voltage is less than 17V, the protection device 10 will maintain the fire protection control unit disconnected from the backup power supply, and the power level indication module 40 lights a red light.

In the description of this disclosure, any process or method description shown in a flowchart or described in other ways herein can be understood to mean that it includes one or more modules, fragments, or parts of codes of executable instructions for implementing customized logic functions or steps of the process. The scope of the preferred embodiments of the present disclosure includes additional implementations which may not perform functions in the order shown or discussed, including a substantially simultaneous manner or in the reverse order according to involved functions, which should be understood by those skilled in the art to which the embodiments of the present disclosure belong.

The logic and/or steps represented in the flowchart or described in other ways herein, for example, can be considered as a sequenced list of executable instructions for implementing logic functions, and can be embodied in any computer-readable medium for use by an instruction execution system, device, or apparatus (such as a computer-based system, a system including a processor, or other system that can fetch and execute instructions from the instruction execution system, device, or apparatus), or for use in combination with the instruction execution system, device or apparatus. For the purposes of the description, a "computer-readable medium" can be any device that can contain, store, communicate, propagate, or transmit a program for use by an instruction execution system, device, or apparatus or for use in combination with the instruction execution system, device, or apparatus. More specific examples (non-exhaustive list) of the computer-readable medium include an electrical connection (electronic apparatus) with one or more wiring, a portable computer disk case (a magnetic device), a Random Access Memory (RAM), a Read-Only Memory (ROM), an Erasable and Programmable Read-Only Memory (EPROM or flash memory), a fiber optic device, and a portable Compact Disk Read-Only Memory (CDROM). In addition, the computer-readable medium may even be paper or other suitable medium on which the program can be printed, because for example the paper or the other medium can be optically scanned, and then be edited, interpreted, or processed in other suitable manner if necessary to obtain the program electronically and the program can be stored in a computer memory.

It should be understood that each part of the present disclosure can be implemented by hardware, software, firmware or a combination thereof. In the above embodiments, multiple steps or methods can be implemented by software or firmware stored in a memory and executed by a suitable instruction execution system. For example, if it is implemented by hardware as in another embodiment, it can be implemented by any one of or a combination of the following technologies well known in the art: discrete logic circuits having logic gate circuits for implementing logic functions on data signals, application specific integrated circuits with a suitable combination of logic gate circuits, a programmable gate array (PGA), a field programmable gate array (FPGA), etc.

A person of ordinary skill in the art can understand that all or part of the steps in the method of any of the foregoing embodiments can be completed by a program instructing relevant hardware. The program can be stored in a computer-readable storage medium. When the program is executed, it implements one of the steps or any combination thereof in the method in any of the embodiments.

In addition, the functional units in the various embodiments of the present disclosure may be integrated in one processing module, or each functional unit may exist alone physically, or two or more units may be integrated into one module. The above-mentioned integrated module can be implemented in the form of hardware or software functional module. If the integrated module is implemented in the form of a software function module and sold or used as an independent product, it can also be stored in a computer-readable storage medium.

The aforementioned storage medium may be a read-only memory, a magnetic disk or an optical disk, etc. Although the embodiments of the present disclosure have been shown and described above, it can be understood that the above-mentioned embodiments are exemplary and should not be construed as limiting the present disclosure. Those of ordinary skill in the art can make changes, modifications, substitutions, and variations to the above embodiments within the range of the present disclosure.

In the illustration of this description, an illustration with reference to the terms "one embodiment", "some embodiments", "illustrative embodiments", "an example", "a particular example" or "some examples" and so on mean that a particular feature, structure, material, or characteristic described in connection with the embodiment(s) or example(s) is included in at least one embodiment or example of the present disclosure. In this description, the exemplary expressions of the above terms do not necessarily specify the same embodiments or examples.

Although embodiments of the present disclosure have been shown and described, it will be understood by those skilled in the art that various changes, modifications, alternations and variations may be made to these embodiments without departing from the principles and spirit of the present disclosure, the scope of which is defined by the claims and their equivalents.

What is claimed is:

1. A method for protecting a backup power supply, applied to an energy storage power station, wherein the energy storage power station comprises a load, the load is connected to the backup power supply for being powered, and the method comprises:
obtaining, when the backup power supply is in a power-supplying state, a power-supplying state parameter of the backup power supply; and
controlling a power-supplying connection state between the backup power supply and the load based on the power-supplying state parameter.

2. The method for protecting the backup power supply according to claim 1, wherein said controlling the power-supplying connection state between the backup power supply and the load based on the power-supplying state parameter comprises:
determining whether the power-supplying state parameter meets a power-off protection condition;
controlling, in response to that the power-supplying state parameter meets the condition, the power-supplying connection state between the backup power supply and the load to be a disconnected state; and
controlling, in response to that the power-supplying state parameter does not meet the condition, the power-supplying connection state between the backup power supply and the load to be a connected state and maintaining power supplying.

3. The method for protecting the backup power supply according to claim 2, wherein the power-supplying state parameter comprises one or more of a power-supplying duration of the backup power supply and an available power-supplying voltage of the backup power supply.

4. The method for protecting the backup power supply according to claim 3, wherein when determining whether the power-supplying state parameter meets the power-off protection condition, a priority of determining the power-supplying duration is higher than a priority of determining the available power-supplying voltage.

5. The method for protecting the backup power supply according to claim 1, wherein the energy storage power station further comprises a main power supply for supplying power to the backup power supply and/or the load, the method further comprises:
controlling, when it is determined that the main power supply is in an abnormal state, the backup power supply to enter the power supplying state.

6. The method for protecting the backup power supply according to claim 5, the method further comprising:
obtaining an available power-supplying voltage of the backup power supply after determining that the main power supply has recovered from the abnormal state to a normal state; and
controlling the power-supplying connection state between the backup power supply and the load based on the available power-supplying voltage.

7. The method for protecting the backup power supply according claim 6, wherein said controlling the power-supplying connection state between the backup power supply and the load based on the available power-supplying voltage comprises:
controlling, when it is determined that the available power-supplying voltage is greater than or equal to a first preset power-supplying voltage, the power-supplying connection state between the backup power supply and the load to be a connected state and stopping the power supplying; and
controlling, when it is determined that the available power-supplying voltage is smaller than the first preset power-supplying voltage, the power-supplying connection state between the backup power supply and the load to be a disconnected state.

8. The method for protecting the backup power supply according to claim 6, further comprising:
transmitting, when it is determined that the available power-supplying voltage is greater than a second preset power-supplying voltage, a first-level power level indication signal;
transmitting, when it is determined that the available power-supplying voltage is less than or equal to the second preset power-supplying voltage and is greater than or equal to the first preset power-supplying voltage, a second-level power level indication signal; and
transmitting, when it is determined that the available power-supplying voltage is less than the first preset power-supplying voltage, a third-level power level indication signal.

9. The method for protecting the backup power supply according to claim 7, further comprising:
transmitting, when it is determined that the available power-supplying voltage is greater than a second preset power-supplying voltage, a first-level power level indication signal;
transmitting, when it is determined that the available power-supplying voltage is less than or equal to the second preset power-supplying voltage and is greater than or equal to the first preset power-supplying voltage, a second-level power level indication signal; and
transmitting, when it is determined that the available power-supplying voltage is less than the first preset power-supplying voltage, a third-level power level indication signal.

10. A device for protecting a backup power supply, comprising:
at least one processor; and
a memory communicatively connected to the at least one processor;
wherein the memory stores a computer program executable by the at least one processor, the computer program when executed by the at least one processor, implements operations of:
obtaining, when the backup power supply is in a power-supplying state, a power-supplying state parameter of the backup power supply; and
controlling a power-supplying connection state between the backup power supply and the load based on the power-supplying state parameter.

11. The device for protecting a backup power supply according to claim 10, wherein said controlling the power-supplying connection state between the backup power supply and the load based on the power-supplying state parameter comprises:
determining whether the power-supplying state parameter meets a power-off protection condition;
controlling, in response to that the power-supplying state parameter meets the condition, the power-supplying connection state between the backup power supply and the load to be a disconnected state; and
controlling, in response to that the power-supplying state parameter does not meet the condition, the power-supplying connection state between the backup power supply and the load to be a connected state and maintaining power supplying.

12. The device for protecting a backup power supply according to claim 11, wherein the power-supplying state parameter comprises one or more of a power-supplying duration of the backup power supply and an available power-supplying voltage of the backup power supply.

13. The device for protecting a backup power supply according to claim 12, wherein when determining whether the power-supplying state parameter meets the power-off protection condition, a priority of determining the power-supplying duration is higher than a priority of determining the available power-supplying voltage.

14. The device for protecting a backup power supply according to claim 10, wherein the energy storage power station further comprises a main power supply for supplying power to the backup power supply and/or the load, the computer program when executed by the at least one processor, further implements operations of:
controlling, when it is determined that the main power supply is in an abnormal state, the backup power supply to enter the power supplying state.

15. The device for protecting a backup power supply according to claim 14, the computer program when executed by the at least one processor, further implements operations of:
obtaining an available power-supplying voltage of the backup power supply after determining that the main power supply has recovered from the abnormal state to a normal state; and
controlling the power-supplying connection state between the backup power supply and the load based on the available power-supplying voltage.

16. The device for protecting a backup power supply according to claim 15, wherein said controlling the power-supplying connection state between the backup power supply and the load based on the available power-supplying voltage comprises:
controlling, when it is determined that the available power-supplying voltage is greater than or equal to a first preset power-supplying voltage, the power-supplying connection state between the backup power supply and the load to be a connected state and stopping the power supplying; and
controlling, when it is determined that the available power-supplying voltage is smaller than the first preset power-supplying voltage, the power-supplying connection state between the backup power supply and the load to be a disconnected state.

17. The device for protecting a backup power supply according to claim 15, the computer program when executed by the at least one processor, further implements operations of:
transmitting, when it is determined that the available power-supplying voltage is greater than a second preset power-supplying voltage, a first-level power level indication signal;
transmitting, when it is determined that the available power-supplying voltage is less than or equal to the second preset power-supplying voltage and is greater than or equal to the first preset power-supplying voltage, a second-level power level indication signal; and
transmitting, when it is determined that the available power-supplying voltage is less than the first preset power-supplying voltage, a third-level power level indication signal.

18. The device for protecting a backup power supply according to claim 16, the computer program when executed by the at least one processor, further implements operations of:
transmitting, when it is determined that the available power-supplying voltage is greater than a second preset power-supplying voltage, a first-level power level indication signal;
transmitting, when it is determined that the available power-supplying voltage is less than or equal to the second preset power-supplying voltage and is greater than or equal to the first preset power-supplying voltage, a second-level power level indication signal; and
transmitting, when it is determined that the available power-supplying voltage is less than the first preset power-supplying voltage, a third-level power level indication signal.

19. An energy storage power station, comprising:
a backup power supply and a load connected to the backup power supply for being powered; and
a device for protecting the backup power supply, wherein the device for protecting the backup power supply is arranged between the backup power supply and the load, the device for protecting the backup power supply comprises at least one processor and a memory communicatively connected to the at least one processor;
wherein the memory stores a computer program executable by the at least one processor, the computer program when executed by the at least one processor, implements operations of:
obtaining, when the backup power supply is in a power-supplying state, a power-supplying state parameter of the backup power supply; and
controlling a power-supplying connection state between the backup power supply and the load based on the power-supplying state parameter.

20. The energy storage power station according to claim 19, wherein said controlling the power-supplying connection state between the backup power supply and the load based on the power-supplying state parameter comprises:
determining whether the power-supplying state parameter meets a power-off protection condition;
controlling, in response to that the power-supplying state parameter meets the condition, the power-supplying connection state between the backup power supply and the load to be a disconnected state; and
controlling, in response to that the power-supplying state parameter does not meet the condition, the power-supplying connection state between the backup power supply and the load to be a connected state and maintaining power supplying.
